(19) United States
(12) Patent Application Publication
(10) Pub. No.: US 2015/0257575 A1
(43) Pub. Date: Sep. 17, 2015

(54) COOKING UNIT AND ASSEMBLY THEREOF

(71) Applicant: SENSIO INC., Montréal (CA)

(72) Inventors: Jamie Coblentz, Montreal (CA); Venesa Solipa, Montreal (CA); Victor Becerra, Westmount (CA)

(21) Appl. No.: 14/434,815

(22) PCT Filed: Feb. 18, 2013
(86) PCT No.: PCT/CA2013/000143

§ 371 Date: Apr. 10, 2015

Related U.S. Application Data
(60) Provisional application No. 61/753,644, filed on Jan. 17, 2013.

(51) Int. Cl. A47J 27/12; A47J 27/00

(52) U.S. Cl. CPC A47J 27/12; A47J 27/002; A47J 27/004

(57) ABSTRACT

An assembly of cooking units includes a first cooking unit having a top surface and first and second side surfaces. The top surface includes an area adapted to receive a cooking device. A first portion of an electrical connector is disposed on the first side surface. A second cooking unit has a top surface and first and second side surfaces. The top surface includes an area adapted to receive a cooking device. A second portion of the electrical connector is disposed on the second side surface. The second portion of the electrical connector is connectable to the first portion of the connector. When in operation, the electrical connector conducts electricity between the first and second cooking units. A first cooking unit of an assembly including at least the first cooking unit and a second cooking unit is also provided.

### BACKGROUND

Slow cookers are countertop electrical cooking appliances that are used for simmering. They require maintaining a relatively low temperature for several hours, allowing unattended cooking of pot roast, stews, soups, “boiled” dinners and other suitable dishes. They are also used to maintain the food at serving temperature.

While the slow cooker is usually a single slow cooker used for preparing dinners of a family, recent versions include multiple slow cookers in the shape of multiple cooking pots (usually three) embedded in a single appliance. The multiple pots allow to serve guests with various dishes during a party. The multiple pots are disposed next to each other in a straight line or sometimes in a circle which make the device cumbersome to handle and to store. Further it may happen that only two out of the three pots of a slow cooker are in use at a given time, which leaves a pot unused empty on the party table. Also, a family typically owns a slow cooker as well as a multiple pots party appliance (e.g. a triple slow cooker) which makes the use of the two slow cookers redundant. In some cases, there is a need during a dinner party of multiple appliances for cooking and serving whether these are slow cookers or not. These appliances may not have cooperative shapes between each other, and they may take up large amounts of counterpace.

### BRIEF SUMMARY

Accordingly, there is provided an assembly of cooking units. The assembly comprises a first cooking unit including a top surface and first and second side surfaces. The top surface includes an area adapted to receive a cooking device. A first portion of an electrical connector is disposed on the first side surface. A second cooking unit includes a top surface and first and second side surfaces. The top surface includes an area adapted to receive a cooking device. A second portion of the electrical connector is disposed on the second side surface of the second cooking unit. The second portion of the electrical connector is connectable to the first portion of the connector. When the second portion of the electrical connector is connected to the first portion of the connector, the electrical connector is adapted to conduct electricity between the first and second cooking units.

In one embodiment, the first side surface of the first and second cooking units is a left side surface, and the second side surface of the first and second cooking units is a right side surface.

In one embodiment, at least a portion of the first side surface of the first cooking unit is slidable into at least a portion of the second side surface of the second cooking unit.

In one embodiment, in the first side surface of the first cooking unit includes a recess, and the second side surface of the second cooking unit includes a protrusion. The cooperates with the protrusion.

In one embodiment, the first portion of the electrical connector is a male connector, and the second portion of the electrical connector is a female connector.

In one embodiment, at least one of the first and second cooking units includes an outlet. The outlet is adapted to connect to a power cable for connecting the first and second cooking units to the electric network.

In one embodiment, the outlet is one of the first and second portions of the electrical connector.

In one embodiment, the first cooking unit includes a first lock portion, and the second cooking unit includes a second lock portion. The first lock portion cooperates with the second lock portion to connect the first and second cooking units to each other.

In one embodiment, the first lock portion is disposed on the first side surface of the first cooking unit, and the second lock portion is disposed on the second side surface of the second cooking unit.

In one embodiment, the top surface of the first cooking unit includes at least one first portion adapted to receive a corresponding at least second portion of a bottom surface of the second cooking unit so as to stack the second cooking unit on top of the first cooking unit.

In one embodiment, a bottom surface of the first cooking unit includes at least one third portion adapted to connect to a corresponding at least fourth portion of the top surface of the second cooking unit so as to stack the first cooking unit on top of the second cooking unit.

In one embodiment, the at least one first portion is a recess, the at least one second portion is a protrusion, the at least one third portion is a protrusion, and the at least fourth portion is a recess.

In one embodiment, the electrical connector is a first connector, the second cooking unit includes a first portion of a second electrical connector, the first portion is disposed on the first side surface of the second cooking unit. The assembly further comprises a third cooking unit having a top surface and first and second side surfaces. The top surface includes an area adapted to receive a cooking device. A second portion of the second electrical connector is disposed on the second side surface of the third cooking unit. The second portion of the second electrical connector is connectable to the first portion of the second electrical connector of the second cooking unit. When the first portion of the second electrical connector is connected to the second portion of the second electrical connector, the second electrical connector is able to conduct electrify between the second and third cooking units.

In one embodiment, the first side surface of the third cooking unit is a left side surface, and the second side surface of the third cooking unit is a right side surface.

In one embodiment, at least a portion of the second side surface of the third cooking unit is slidable into at least a portion of the first side surface of the second cooking unit.

In one embodiment, the second side surface of the third cooking unit includes a recess. The first side surface of the second cooking unit includes a protrusion. The recess cooperates with the protrusion.

In one embodiment, the first portion of the second electrical connector is a male connector, and the second portion of the electrical connector is a female connector.

In one embodiment, at least one of the first, second and third cooking units includes an outlet. The outlet is adapted to connect to a power cable for connecting the first, second and third cooking units to the electricity network when the first portion of the first electrical connector is connected to the second portion of the first electrical connector, and when the first portion of the second electrical connector is connected to the second portion of the second electrical connector.

In one embodiment, the outlet is one of the first and second portions of the first and second electrical connectors.

In one embodiment, the third cooking unit includes a first lock portion, and the second cooking unit includes a second lock portion. The first lock portion cooperates with the second lock portion to connect the third and second cooking units to each other.

In one embodiment, the first lock portion is disposed on the second side surface of the third cooking unit, and the second lock portion is disposed on the first side surface of the second cooking unit.

In one embodiment, a bottom surface of the third cooking unit includes at least one first portion adapted to engage a corresponding at least second portion of the top surface of the second cooking unit so as to stack the third cooking unit on top of the second cooking unit.

In one embodiment, at least one of the first, second and third cooking units is a slow cooker. The area of the at least one of the first, second and third cooking units is a recess. The cooking device of the at least one of the first, second and third cooking units is a slow cooker bowl.

A first cooking unit of an assembly including at least the first cooking unit and a second cooking unit is also provided. The first cooking unit comprises a body having a top surface and first and second side surfaces. The top surface includes an area adapted to receive a cooking device. A first portion of an electrical connector is disposed on the first side surface. The first portion of the electrical connector is adapted to connect to a second portion of the electrical connector located on the second cooking unit of the assembly for conducting electricity between the first and second cooking units.

In one embodiment, the electrical connector is a first electrical connector. A second portion of a second electrical connector is disposed on the second side surface. The second portion is adapted to connect to a first portion of the electrical connector located on a third cooking unit of the assembly for conducting electricity between the first and third cooking units.

In one embodiment, the second portion of a first electrical connector is identical to the second portion of a second electrical connector.

In one embodiment, the body includes a top surface and a bottom surface. The top surface of the first cooking unit includes at least one first portion adapted to receive a corresponding second portion of a bottom surface of the second cooking unit so as to stack the second cooking unit on top of the first cooking unit. The bottom surface of the first cooking unit includes at least one third portion adapted to connect to a corresponding fourth portion of a top surface of the second cooking unit so as to stack the first cooking unit on top of the second cooking unit.

In one embodiment, the at least one first portion is a recess, and the at least one third portion is a protrusion.

In one embodiment, the first cooking unit is a slow cooker, the area is a recess, and the cooking device is a slow cooker bowl.

Embodiments of the present can have at least one of the above-mentioned aspects, but do not necessarily have all of them.

Additional and/or alternative features, aspects, and advantages of embodiments of the present will become apparent from the following description, the accompanying drawings, and the appended claims.

### BRIEF DESCRIPTION OF THE DRAWINGS

For a better understanding of the present, as well as other aspects, and further features thereof, reference is made to the following description which is to be used in conjunction with the accompanying drawings, where:

FIG. 1 is a perspective view taken from a top, front, right side of an assembly of three connectable cooking units, in the shape of slow cookers, shown connected to each other in a serving position with one of the cooking units having its lid held on a lid rest;

FIG. 2 is a perspective view from a top, rear, left side of the assembly of the three connectable cooking unit of FIG. 1;

FIG. 3 is a perspective view taken from a top, front, right side of one of the three cooking unit shown in isolation;

FIG. 4 is a left side view of the cooking unit of FIG. 3;

FIG. 5 is a right side view of the cooking unit of FIG. 3;

FIG. 6 is a bottom plan view of the cooking unit of FIG. 3;

FIG. 7 is a front view of two of the three connectable cooking units of FIG. 1 shown disconnected with an arrow indicating a direction of connection and disconnection; and

FIG. 8 is a perspective view taken from a front, top left side of the cooking assembly of FIG. 1 shown disconnected and in a stored or stacked position.

### DETAILED DESCRIPTION

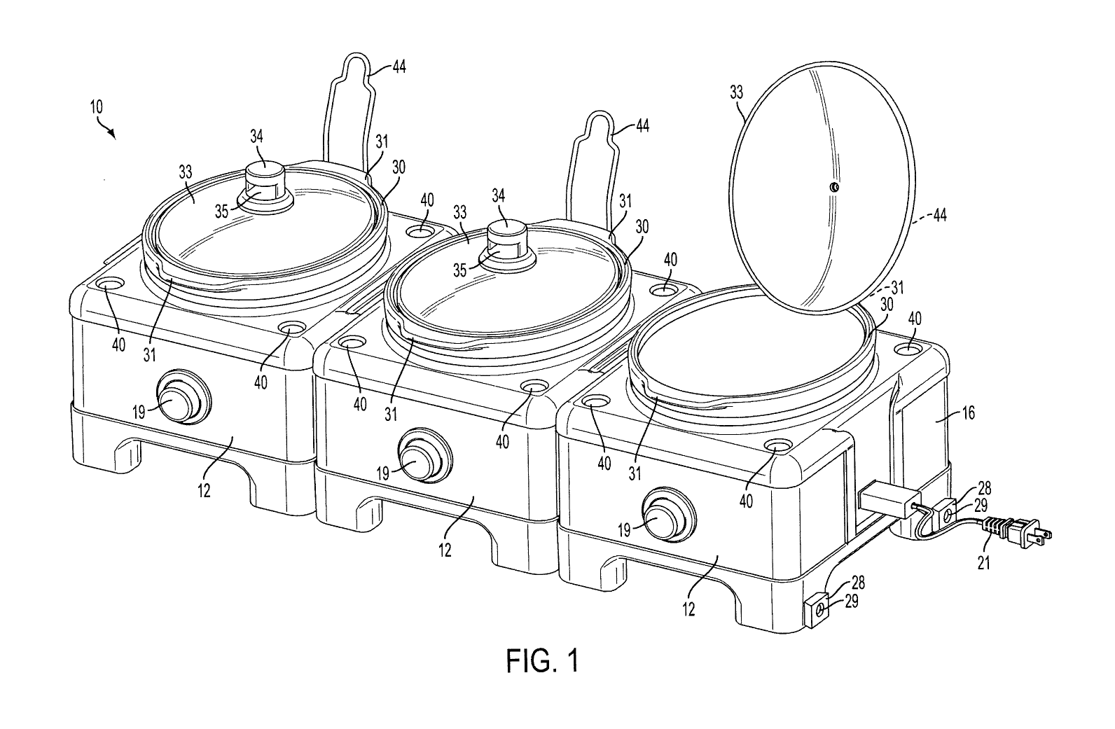

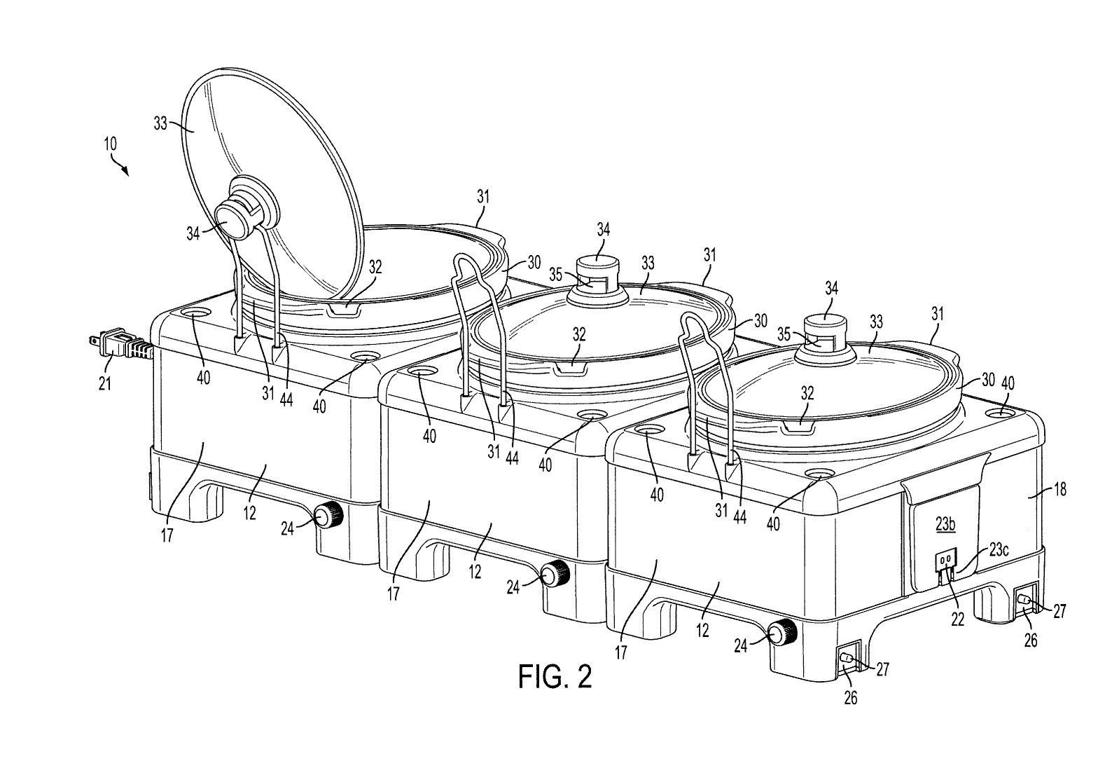

Referring to FIGS. 1 and 2, an assembly 10 of three connectable and stackable cooking units 12, in the shape of slow cookers, will be described. The assembly 10 includes three cooking units 12 that are connectable, detachable and stackable with each other. The cooking units 12 are shown in FIGS. 1 and 2 in a connected (or serving) position. In the connected position, the cooking units 12 are mechanically and electrically coupled to each other. They can be used for cooking or for keeping the food at serving temperature. Although the cooking units 12 described herein are slow cookers, it is contemplated that the assembly 10 could include cooking units other than slow cookers. For example, the assembly 10 could include one or more rice cooker, a deep fryer or a cooking/warming plate. Although the following description will refer to an assembly of three cooking units 10, it is contemplated that the assembly could have only two or more than three cooking units. In one example, the assembly 10 includes six cooking units. In another example, power could allow the assembly 10 to include ten cooking units.

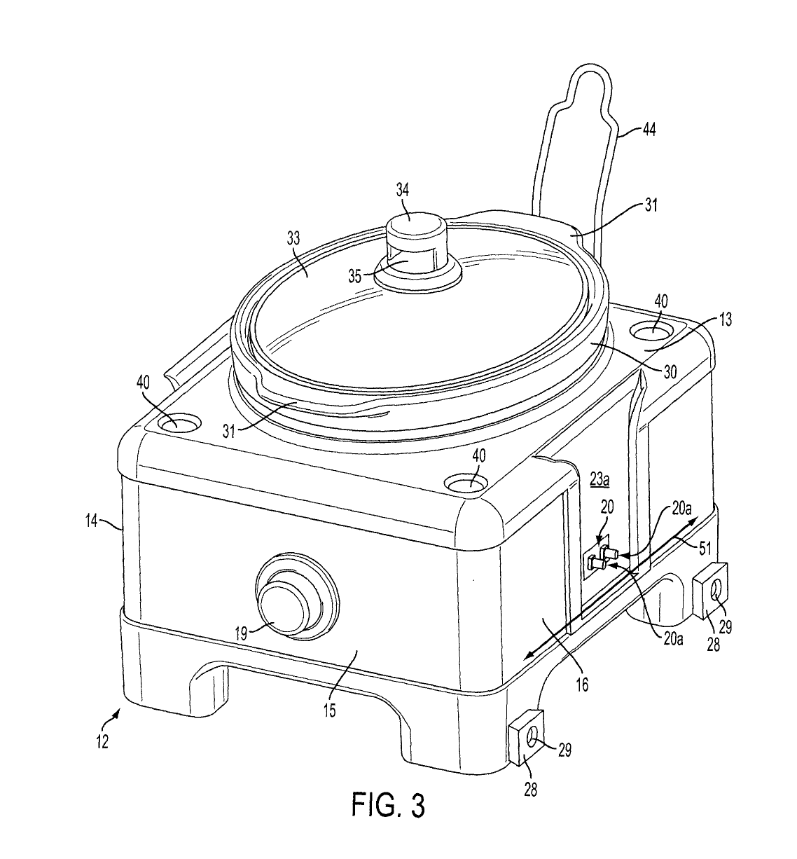

Turning now to FIGS. 3 to 6, each of the cooking unit 12 being identical, only one cooking unit 12 will be described. Although the cooking units 12 are identical to each other in the embodiment shown in the Figures, it is contemplated that one or more of the cooking units 12 could have a size and/or shape different from the other ones. For example, one of the cooking units 12 could be longer than the other ones to accommodate a griddle or a cooking plate while the other cooking units could be shorter and accommodate slow cooker and/or rice cookers.

The cooking unit 12 has a generally rectangular body 14 with blunt edges. It is contemplated that the body 14 could have a shape different from the shape shown in the

Figures. For example, the body 14 could be round, oval, or shaped like a portion of a pie. In another example, the body 14 is rectangular and/or has sharp edges. The body 14 has a bottom surface 11, a top surface 13, a front surface 15, a right side surface 16, a rear surface 17, and a left side surface 18.

Referring more specifically to FIG. 3, the front surface 15 of the cooking unit 12 includes a dial 19. The dial 19 allows to operate each of the cooking units 12 individually from one another even when the cooking units 12 are connected to each other in the manner shown in FIG. 1. The dial 19 has four settings: off, low, high and warm. Low is used to slow cook, warm is used to keep the food at tasting temperature while not cooking the food, and high is used for slow cooking in a faster way than regular slow cooking yet below simmering temperature. Since the dials 19 are independent from each other, when in operation one of the cooking unit 12 could be at a first cooking temperature, while another cooking unit 12 connected to the previous mentioned cooking unit 12 could be at a second temperature different from the first temperature. In another example, one of the cooking units 12 could be at a cooking temperature, while another cooking unit 12 could be at a serving temperature where the food is keep hot but is not cooking. It is contemplated that the dial 19 could be disposed elsewhere on the cooking unit 12. For example, the dial 19 could be disposed on the front surface 15 toward a right side. It is also contemplated that operation of the cooking unit 12 could be achieved by ways other than the dial 19. For example, a plurality of buttons or a touch screen could be used.

The top surface 13 of the body 14 includes an opening (not shown) to receive a slow cooker bowl 30. It is contemplated that the top surface 13 could not have an opening. For example, should the cooking unit 12 be a stove top burner or a griddle. It is also contemplated that the top surface 13 could have an opening for receiving a bowl other than the cooking bowl 30 for a slow cooker. For example, the bowl could be a bowl for a rice cooker or for a deep fryer.

The cooking bowl 30 is made of ceramic and receives the food to be cooked. The cooking bowl 30 has a capacity of 2.5 Qt. The cooking bowl 30 has two handles 31 to facilitate its extraction and positioning into the opening. The cooking bowl 30 also includes a recess 32 on its rim to allow a serving spoon to rest there. It is contemplated that the handles 31 and/or the recess 32 could be omitted. The opening and cooking bowl 30 are oval, but it is contemplated that the recess and cooking bowl 30 could be circular or have another suitable shape. It is also contemplated that the cooking bowl 30 could have a higher or a smaller capacity. For example, the cooking bowl could have a capacity of 2.0 Qt. It is also contemplated that the cooking bowl 30 could have a divider so as to cook simultaneously two dishes. It is contemplated that the cooking bowl 30 could be made of a material other than ceramic. For example, the cooking bowl 30 could be made of aluminum or i-cast.

The cooking bowl 30 is removably covered by a lid 33. The lid 33 is made of transparent glass and has a knob 34 at a top thereof to manipulate the lid 33. The knob 34 is made of plastic and is attached to the lid 33 by a screw (not shown). The knob 34 includes an opening 35 to allow the lid to be placed onto a lid holder 44 as shown in FIGS. 1 and 2. It is contemplated that the lid 33 could be opaque or could be made of a material other than glass. For example, the lid 33 could be made of ceramic or plastic. It is also contemplated that the knob 34 could not include the opening 35. It is contemplated that the lid holder 44 could be omitted.

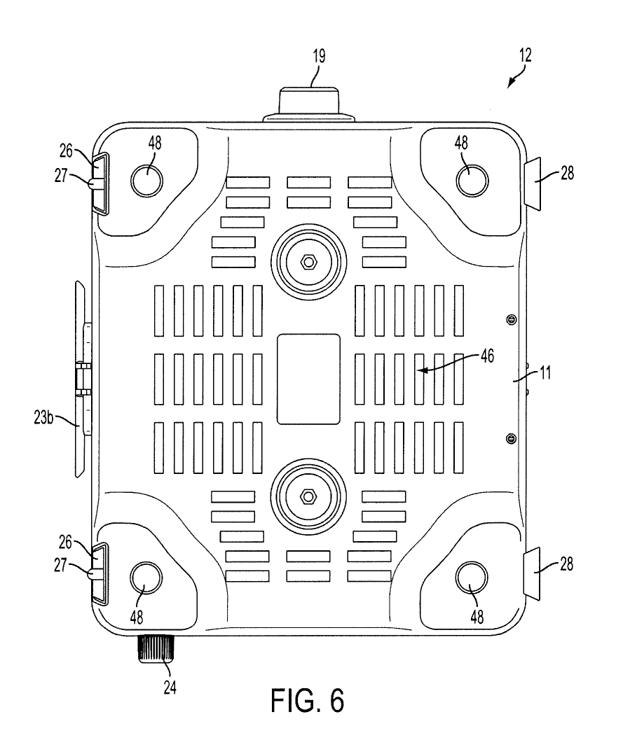

The top surface 13 is generally flat around the opening and adapted to cooperate with the bottom surface 11 of another one of the cooking units 12 so that the cooking units 12 can be stacked on top of each other. The top surface 13 includes four recesses 40, each one disposed at a corner of the top surface 13. The recesses 40 are shaped and dimensioned to receive corresponding feet pads 48 (shown in FIG. 6) of other ones of the cooking units 12 when disposed one on top of the other. It is contemplated that the recesses 40 could be omitted. It is also contemplated that the cooking units 12 could include locks to secure them to each other when disposed one on top of another.

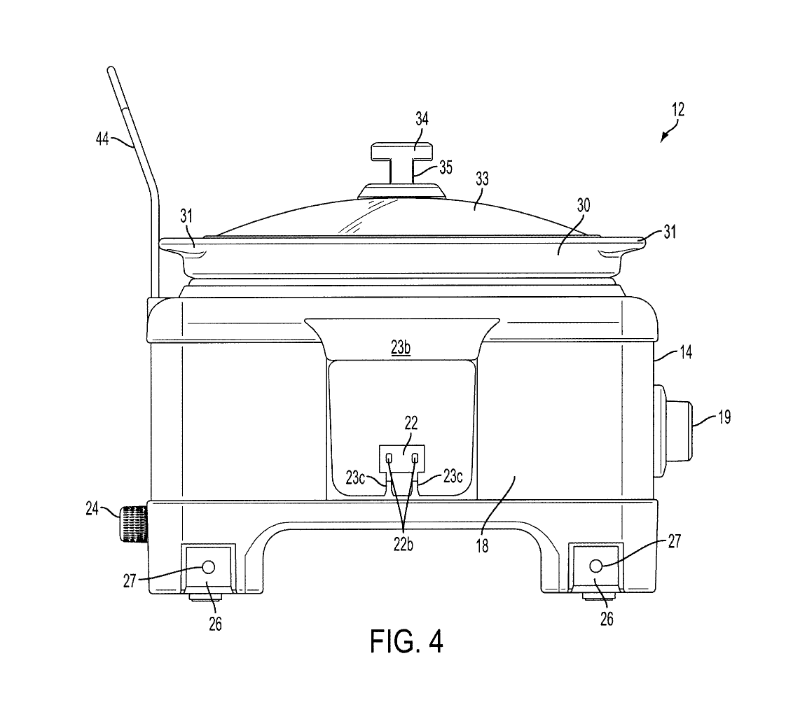

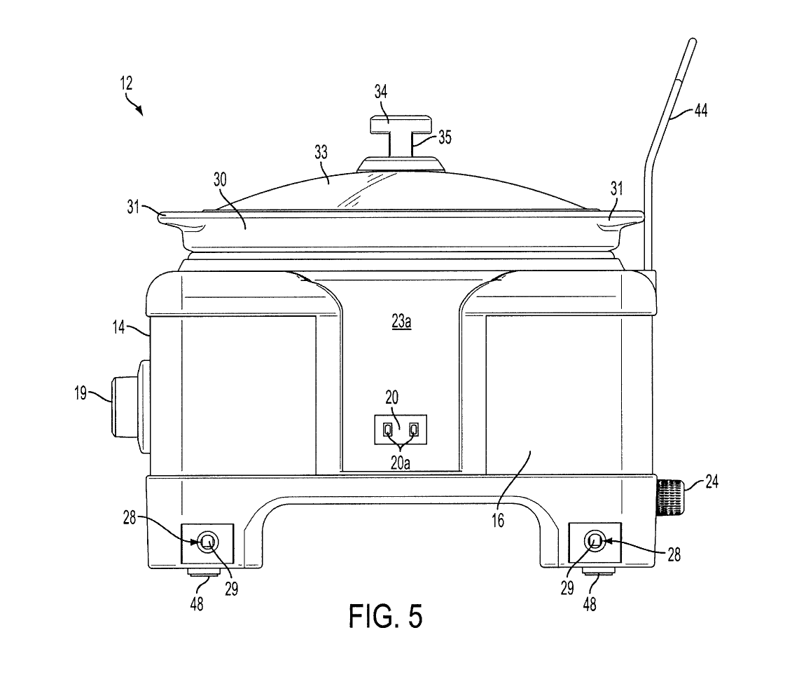

Referring now to FIGS. 4 and 5, the right and left side surfaces 16, 18 of the cooking unit 12 are designed to cooperate with left and right surfaces 18, 16 respectively of the other cooking units 12. The right side surface 16 includes a male connector 20, and the left side surface 18 includes a female connector 22 which together forms an electric connection between the cooking unit 12. As a consequence, only one cable 21 is needed to operate one, two or the three cooking units 12 when they are connected to each other by the male and female connectors 20, 22. Should the assembly include more than three cooking units 12, only on cable 21 would also be sufficient to power the assembly of cooking units 12 connected to each other.

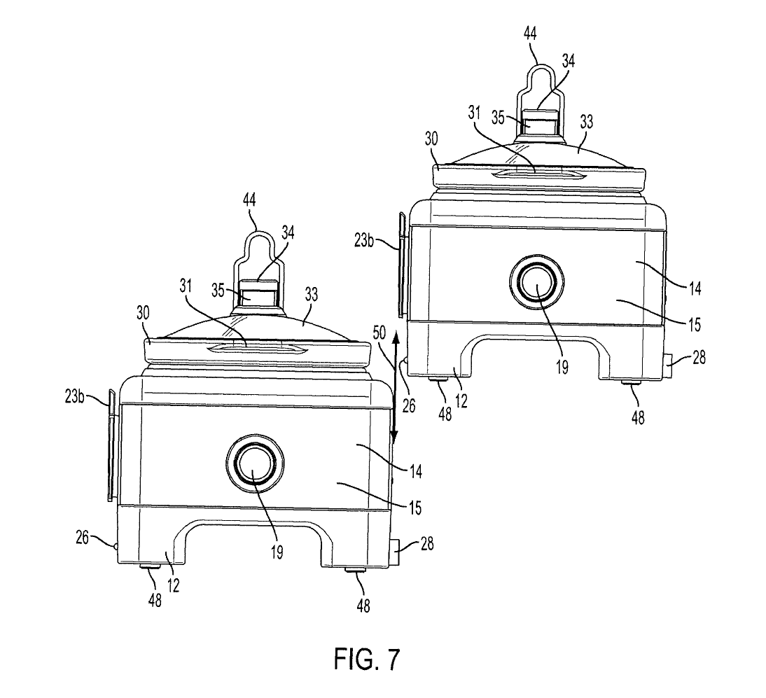

The male connector 20 is insertable into the female connector 22 via a vertical sliding action as best illustrated by arrow 50 in FIG. 7. The male connector 20 is disposed in a generally V-shaped recess (or groove) 23a on the right side surface 16, while the female connector 22 is disposed in a generally I-shaped protrusion or tongue 23b on the left side surface 18. The recess 23a and protrusion 23b cooperate with each other to guide the cooking units 12 during connection to each other. The recess 23a and protrusions 23b also provide some mechanical connection between the cooking units 12 by preventing lateral motion (indicated by arrow 51 in FIG. 3) between the cooking unit 12.

The male connector 20 includes two prongs 20a. The female connector 22 includes two recesses 22b which are adapted to cooperate with the two prongs 20a. The recesses 22b are covered by a door which is spring biased toward a closed position. In the closed position, the recesses 22b are covered by the door. Upon insertion of the protrusion 23b in slits 23c, the prongs 20a force the door to open which allows the prongs 20 a to insert into the recesses 22b thereby connecting the male connector 20 to the female connector 22. It is contemplated that electrical coupling of the cooking units 12 could be achieved by a suitable manner other than by the slidable male/female connectors 20,22. For example, an inter-cooking-units cable or adaptor (that would not work in a wall outlet) could connect two cooking units to each other. The inter-cooking-units cable or adapter would allow the cooking units 12 to be electrically connected yet not abutting each other. It is also contemplated that the cooking units 12 which are disposed at extremities of the assembly 10 could be devoid of any connector 20, 22 on those surfaces which are not to be connected to any other slow cooker. In that case, the cooking unit 12 would not be identical to each other. For example, the right side surface 16 of the most right cooking unit 12 could be without any male connector 20, and that the left side surface 18 of the most left cooking unit 12 could be without any female connector 22. It is also contemplated that the left side surface 18 could include the male connector 20 instead of the female connector 22, and that the right side surface 16 could include the female connector 22 instead of the male connector 20. In another example, one or more of the cooking units 12 could include instead or in addition, a male connector 20 and/or a female connector 22 on the rear surface 17. Such connector on the rear surface 17 would allow to dispose the cooking units 12 in a L-shape.

The male connector 20 can also be used as an outlet to which the cable 21 is inserted for connecting the cooking unit 12 to the electricity network. The cable 21 is a breakaway cable, and houses a female socket (not shown), which can connect to the prongs 20a with a magnet (not shown). It is contemplated that the magnet could be omitted. Although each of the cooking units 12 includes the outlet, when the cooking units 12 are connected to each other, only one outlet is exposed (belonging to one of the two cooking units 12 disposed at extremities) is used by the cable 21 to power all three cooking units 12. It is contemplated that the outlet could be distinct from the male connector 20, and could be disposed elsewhere on the cooking unit 12.

The right and left side surfaces 16, 18 further include a lock made of two parts which cooperate with each other to attach two cooking units 12 together. The lock includes a male portion 26 disposed on the right side surface 18 and a female portion 28 disposed on the right left surface 16, both toward the bottom surface 11 of the cooking unit 12. It is contemplated that female portion 28 could be disposed on the right side surface 16 and the male portion 26 could be disposed on the right side surface 18. The lock is actuated by a knob 24 disposed on the rear surface 17 of the cooking unit 12. Upon rotation of the knob 24, a mechanical coupling (not shown) within the cooking unit 12 ensures that a pin 27 extends outwardly from the male portion 26. When two cooking units 12 are connected into another by the recess 23a and protrusion 23b, the pin 27, when extended, fits into a recess 29 of the female portion 28 thereby locking the male portion 26 to the female portion 28. Although the cooking units 12 can be connected to each other without the lock, the lock brings additional strength of the assembly 10, such that the assembly 10 can be lifted all together and be carried, for example from the kitchen to the serving table. To disconnect the two cooking units 12, the user just rotates the knob 24 in the other direction until the pin 27 is retracted from the recess 29. It is contemplated that the lock could be different from shown herein and could be positioned elsewhere on the cooking unit 12. For example, the lock could include a hook pivotally connected to the rear surface 17 toward one of the right and left side surfaces 16, 18, and a knob fixedly connected to the rear surface 17 toward the other one of the right and left side surfaces to connect to the hook. The lock could be configured so that the hook of one of the cooking units 12 connects with the knob of another one of the cooking units 12. It is contemplated that the pin 27 and recess 29 could be actuated by a lever instead of the knob 24. It is also contemplated that the lock could be omitted.

Turning to FIG. 6, the bottom surface 11 of the cooking unit 12 includes a plurality of air vents 46 and the four feet pads 48. The air vents 46 allow to exchange heat with the outside environment to cool of the internal components. As mentioned above, the bottom surface 11 includes the feet pads 48 which are each disposed at a corner of the bottom surface 11. The feet pads 48 provide added stability to the cooking unit 12 but can also be received in the recesses 40 to facilitate stacking of the cooking units 12 on top of each other.

Referring more specifically to FIG. 7, to connect two cooking units 12 to each other, the user places the two cooking units 12 facing a same direction with male connector 20 of one of the cooking units 12 facing the female connector 22 of an other one of the cooking units 12. The user then lifts one on the cooking units 12 and slides the female connector 22 into the male connector 20 as indicated by arrow 50. The user repeats the same operation with yet another one of the cooking units 12 onto the newly formed assembly of two cooking units 10 should he/she would want to form an assembly of three cooking units. For additional connection, the user may attach the cooking units 12 to each other using the pins 27 and recesses 29 via the knobs 24. To power the assembly of cooking units 12, the user plugs the cable 21 to only one of the cooking units 12 and to the electric network.

The user may want to dispose the cooking units 12 in a manner different from the one shown in the Figures. For example, the user may want to disposed in a L-shape or in a U-shape so as to be disposed at table's corners. To do this, the user could use the inter-cooking-units connector or adapter between those two cooking units that are at the corner of the L-shape. In the case where the cooking unit has a female or male connector at the rear surface 17, the user could just connect the rear surface 17 with a corresponding left or right surface 18, 16 so as to form an L.

To disconnect the cooking units 12, the user turns the knob 24 in the other direction if the cooking units 12 were attached to each other by the pin 27 and recess 29. The user then slides the female connector 22 of one of the cooking units 12 out of the male connector 20 of other one of the cooking units 12 to fully released the cooking units 12 from each other.

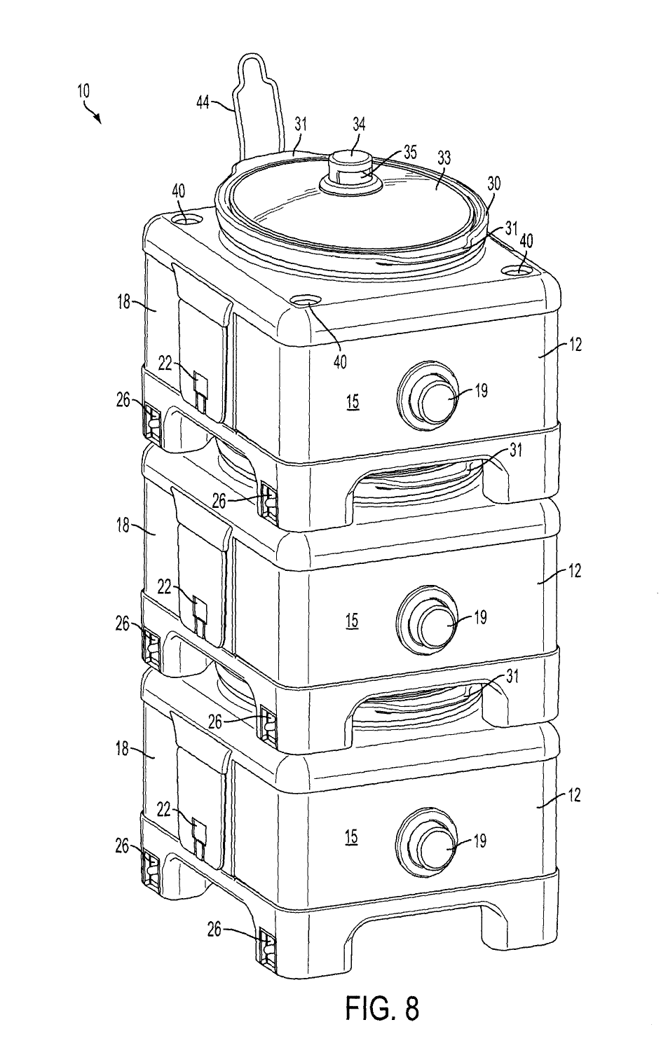

Turning now to FIG. 8, the cooking units 12 are shown in a stacked or stored position. To store the cooking units 12 the user disconnects all the cooking units 12 from each other, as described above. The user may remove the lids 32 or dispose the lids 32 upside down on the cooking bowls 30 to allow the bottom surfaces 11 to be stacked onto the top surfaces 13 of the corresponding cooking units 12 so as to form a vertical stack of cooking units 12. The recesses 40 receive the feet pads 48 of the cooking unit 12 disposed directly above it. The recesses 40 provide additional coupling between the cooking units 12 when stacked vertically, as they forbid some lateral movement between the cooking units 12. It is possible to store only two or three of the cooking units 12 in this manner.

As can be apparent from the above description, the cooking assembly 10 is a versatile device which allows to use either one, two or the three cooking units 12 depending on the dishes that the user wants to cook and/or served. One cable 21 is sufficient to connect either the one, two or the three cooking units 12 to the electric network. The cooking assembly 10 is easily stored by stacking either one, two or the three cooking units 12 on top of each other. Furthermore, with the cooking assembly 10 there is no need to own both a single cooker and a multiple pots party cooker.

Modifications and improvements to the above-described embodiments of the present may become apparent to those skilled in the art. The foregoing description is intended to be exemplary rather than limiting. The scope of the present is therefore intended to be limited solely by the scope of the appended claims.

I/We claim:

1. An assembly of cooking units, the assembly comprising:
a first cooking unit including:
a top surface and first and second side surfaces, the top surface including an area adapted to receive a cooking device; and
a first portion of an electrical connector disposed on the first side surface; and
a second cooking unit including:
a top surface and first and second side surfaces, the top surface including an area adapted to receive a cooking device; and
a second portion of the electrical connector disposed on the second side surface of the second cooking unit, the second portion of the electrical connector being connectable to the first portion of the connector,
when the second portion of the electrical connector is connected to the first portion of the connector, the electrical connector is adapted to conduct electricity between the first and second cooking units.

2. The assembly of claim 1, wherein the first side surface of the first and second cooking units is a left side surface, and the second side surface of the first and second cooking units is a right side surface.

3. The assembly of any one of claims 1 and 2, wherein at least a portion of the first side surface of the first cooking unit is slidable into at least a portion of the second side surface of the second cooking unit.

4. The assembly of any one of claims 1 and 3, wherein the first side surface of the first cooking unit includes a recess; and
the second side surface of the second cooking unit includes a protrusion, the cooperating with the protrusion.

5. The assembly of any one of claims 1 to 4, wherein the first portion of the electrical connector is a male connector; and
the second portion of the electrical connector is a female connector.

6. The assembly of any one of claims 1 to 5, wherein at least one of the first and second cooking units includes an outlet, the outlet being adapted to connect to a power cable for connecting the first and second cooking units to the electric network.

7. The assembly of claim 6, wherein the outlet is one of the first and second portions of the electrical connector.

8. The assembly of any one of claims 1 to 6, wherein the first cooking unit includes a first lock portion, and the second cooking unit includes a second lock portion; the first lock portion cooperating with the second lock portion to connect the first and second cooking units to each other.

9. The assembly of claim 8, wherein the first lock portion is disposed on the first side surface of the first cooking unit, and the second lock portion is disposed on the second side surface of the second cooking unit.

10. The assembly of any one of claims 1 to 9, wherein the top surface of the first cooking unit includes at least one first portion adapted to receive a corresponding at least second portion of a bottom surface of the second cooking unit so as to stack the second cooking unit on top of the first cooking unit.

11. The assembly of claim 10, wherein a bottom surface of the first cooking unit includes at least one third portion adapted to connect to a corresponding at least fourth portion of the top surface of the second cooking unit so as to stack the first cooking unit on top of the second cooking unit.

12. The assembly of claim 11, wherein the at least one first portion is a recess, the at least one second portion is a protrusion, the at least one third portion is a protrusion, and the at least fourth portion is a recess.

13. The assembly of any one of claims 1 to 12, wherein the electrical connector is a first connector;
the second cooking unit includes a first portion of a second electrical connector, the first portion being disposed on the first side surface of the second cooking unit; and further comprising:
a third cooking unit having:
a top surface and first and second side surfaces, the top surface including an area adapted to receive a cooking device; and
a second portion of the second electrical connector disposed on the second side surface of the third cooking unit; the second portion of the second electrical connector being connectable to the first portion of the second electrical connector of the second cooking unit,
when the first portion of the second electrical connector is connected to the second portion of the second electrical connector, the second electrical connector is able to conduct electricity between the second and third cooking units.

14. The assembly of claim 13, wherein the first side surface of the third cooking unit is a left side surface, and the second side surface of the third cooking unit is a right side surface.

15. The assembly of any one of claims 13 and 14, wherein at least a portion of the second side surface of the third cooking unit is slidable into at least a portion of the first side surface of the second cooking unit.

16. The assembly of any one of claims 13 to 15, wherein the second side surface of the third cooking unit includes a recess; and
the first side surface of the second cooking unit includes a protrusion, the recess cooperating with the protrusion.

17. The assembly of any one of claims 13 to 16, wherein the first portion of the second electrical connector is a male connector; and
the second portion of the electrical connector is a female connector.

18. The assembly of any one of claims 13 to 16, wherein at least one of the first, second and third cooking units includes an outlet, the outlet being adapted to connect to a power cable for connecting the first, second and third cooking units to the electric network when the first portion of the first electrical connector is connected to the second portion of the first electrical connector, and when the first portion of the second electrical connector is connected to the second portion of the second electrical connector.

19. The assembly of claim 18, wherein the outlet is one of the first and second portions of the first and second electrical connectors.

20. The assembly of any one of claims 13 to 19, wherein the third cooking unit includes a first lock portion, and the second cooking unit includes a second lock portion; the first lock portion cooperating with the second lock portion to connect the third and second cooking units to each other.

21. The assembly of claim 8, wherein the first lock portion is disposed on the second side surface of the third cooking unit, and the second lock portion is disposed on the first side surface of the second cooking unit.

22. The assembly of any one of claims 13 to 21, wherein a bottom surface of the third cooking unit includes at least one first portion adapted to engage a corresponding at least second portion of the top surface of the second cooking unit so as to stack the third cooking unit on top of the second cooking unit.

23. The assembly of any one of claims 13 to 22, wherein at least one of the first, second and third cooking units is a slow cooker, the area of the at least one of the first, second and third cooking units is a recess, and the cooking device of the at least one of the first, second and third cooking units is a slow cooker bowl.

24. A first cooking unit of an assembly including at least the first cooking unit and a second cooking unit, the first cooking unit comprising:
a body having a top surface and first and second side surfaces, the top surface including an area adapted to receive a cooking device; and
a first portion of an electrical connector disposed on the first side surface, the first portion of the electrical connector being adapted to connect to a second portion of the electrical connector located on the second cooking unit of the assembly for conducting electricity between the first and second cooking units.

25. The first cooking unit of claim 24, wherein the electrical connector is a first electrical connector; and
further comprising a second portion of a second electrical connector disposed on the second side surface, the second portion being adapted to connect to a first portion of the electrical connector located on a third cooking unit of the assembly for conducting electricity between the first and third cooking units.

26. The first cooking unit of claim 25, wherein the second portion of a first electrical connector is identical to the second portion of a second electrical connector.

27. The first cooking unit of any one of claims 24 to 26, wherein the body includes a top surface and a bottom surface, the top surface of the first cooking unit includes at least one first portion adapted to receive a corresponding second portion of a bottom surface of the second cooking unit so as to stack the second cooking unit on top of the first cooking unit, and
the bottom surface of the first cooking unit includes at least one third portion adapted to connect to a corresponding fourth portion of a top surface of the second cooking unit so as to stack the first cooking unit on top of the second cooking unit.

28. The first cooking unit of claim 27, wherein the at least one first portion is a recess, and the at least one third portion is a protrusion.

29. The first cooking unit of any one of claims 24 to 28, wherein the first cooking unit is a slow cooker, the area is a recess, and the cooking device is a slow cooker bowl.
